(19) United States
(12) Patent Application Publication
(10) Pub. No.: US 2007/0180411 A1
(43) Pub. Date: Aug. 2, 2007

(54) Method and apparatus for comparing semiconductor-related technical systems characterized by statistical data

(76) Inventors: Wolfgang Swegat, Villach (AT); Sheetal Jain, Bangalore (IN); Ankur Gupta, Munich (DE)

Correspondence Address: BRINKS HOFER GILSON & LIONE;INFINEON, PO BOX 10395, CHICAGO, IL, 60610, US

(21) Appl. No.: 11/341,900

(22) Filed: Jan. 27, 2006

(51) Int. Cl. G06F 17/50

(52) U.S. Cl. 716/4

(57) ABSTRACT

A method and an apparatus are provided for comparing a first semiconductor-related technical system with a second semiconductor-related technical system using statistical means. First statistical data characterizing the first technical system and second statistical data characterizing the second technical system are provided. A statistical test comparing the first statistical data with the second statistical data is performed after the first and second statistical data has been provided. Whether the first and second technical system are equivalent is then determined depending on the result of the statistical test.

### TECHNICAL FIELD

The present invention relates to methods and apparatuses for comparing semiconductor-related technical systems that are characterized by statistical data. In particular, the present invention relates to methods and apparatuses for comparing technical systems in the fields of semiconductor design and manufacture, for example for comparing fabrication processes or lines or simulation devices for simulating semiconductors.

### BACKGROUND

In the design of modern semiconductor devices, simulations play an increasingly important role helping to minimize the needs for actual prototypes of the devices and therefore helping to save costs. Simulations are employed in yield calculation and yield optimization, in which process variations and the like are simulated in order to obtain information regarding the yield of a production process of the semiconductor device, i.e. the ratio of semiconductor devices which fulfill predetermined requirements regarding their functionality to the overall number of devices produced. In particular, increased miniaturization and decreasing structure sizes of semiconductor devices lead to increased process variations which are taken into account in order not to produce an unreasonable number of defective goods.

To obtain information regarding these issues, Monte-Carlo simulations are performed using statistical models for components of the semiconductor device like transistors. Such simulations are usually carried out during the front-end design, but may also be performed in the post-layout design stage where the layout data is incorporated into the design of the semiconductor device.

In Monte-Carlo simulations random inputs are fed to the device to be simulated, and a statistic of the output values is thus obtained. Simulations may be performed by a SPICE based simulator, SPICE being a general purpose circuit simulations program developed by Berkeley University, California, USA. For the simulation, statistical models for transistors and possibly other components are integrated into the spice simulator. Common spice simulators include SPECTRE® by Cadence and other simulators like ELDO, HSIM, HSPICE and ULTRASIM. These simulators and the corresponding transistor models are routinely used in semiconductor development and shall therefore not be described here in detail.

In some cases, more than one of the above-mentioned simulators are used for simulating a given device, or the simulation program used is changed during the development process. In these cases, the statistical models are migrated for example for the transistor used in one simulation program to another simulation program, since the various programs use different syntax for defining such models. As such transistor models usually use many parameters (for example, the so-called BSIM4.50 transistor model has close to 300 model parameters and process parameters), such a migration is a complex process which is verified in order to make sure that the new statistical model works correctly.

Since the output of the Monte-Carlo simulations performed are statistical distributions rather than fixed values, the statistical distributions are checked to if they are equivalent for the first simulation program used with the original transistor model and the second simulation program with the migrated transistor model.

A similar problem arises if a new version of a particular simulator and/or a particular transistor or other model is released. In this case, it is evaluated whether the new version produces the same results as the older version before integrating the new version into the design flow for a semiconductor device. Also in this case, statistical distributions obtained from the older version and the new version are compared.

A related problem arises when a particular component like a transistor is manufactured in two different fabrication lines, for example in two different semiconductor fabrication plants. In this case, at each of the fabrication lines parameters of the components manufactured, for example a threshold value of a transistor, are measured, to obtain statistical distributions characterizing the components. The distributions are, inter alia, used for determining parameters for the above-mentioned transistor models used in simulations. In this case, the equivalence of the parameters and statistical distributions thusly obtained are checked, for example in order to make sure that the quality produced by both fabrication lines is the same.

In each of the above-listed cases statistical distributions obtained either from simulations, in particular Monte-Carlo simulations, or measurements on actual products have to be compared. Hitherto, this mainly has been done by performing single statistical tests like a mean test and evaluating the results manually, possibly with the help of graphical representations of the distributions to be compared and/or the test results.

However, two distributions significantly differing in shape may have basically the same mean values, as shown exemplary in FIG. 1 where two distributions 1 and 2 are shown. In these figures, the x-axis represents a value for a particular parameter measured or simulated and the y-axis shows the frequency of the values. While both distributions 1 and 2 have the same mean value and thus a mean test may evaluate them as being equivalent, as can be easily seen, distributions 1 and 2 differ significantly. On the other hand, comparing plotted distributions manually is very time-consuming and leads only to a qualitative result without quantifying the differences between two distributions. As mentioned above, some 100 parameters are evaluated for transistor models. Such evaluation is too costly and time-intensive to do manually.

### BRIEF DESCRIPTION OF THE DRAWINGS

The present invention is illustrated by way of example and not limited to the accompanying figures in which like references indicate similar elements. Exemplary embodiments will be explained in the following text with reference to the attached drawings, in which:

FIG. 1 is a graph of two statistical data distributions for illustrating the problem underlying the present invention,

FIG. 2 is a block diagram showing the basic elements of an embodiment of the present invention,

FIG. 3 is a flow diagram showing the steps of an embodiment of the method according to the present invention, and

FIG. 4 is a block diagram of an implementation of the present invention in a computer system.

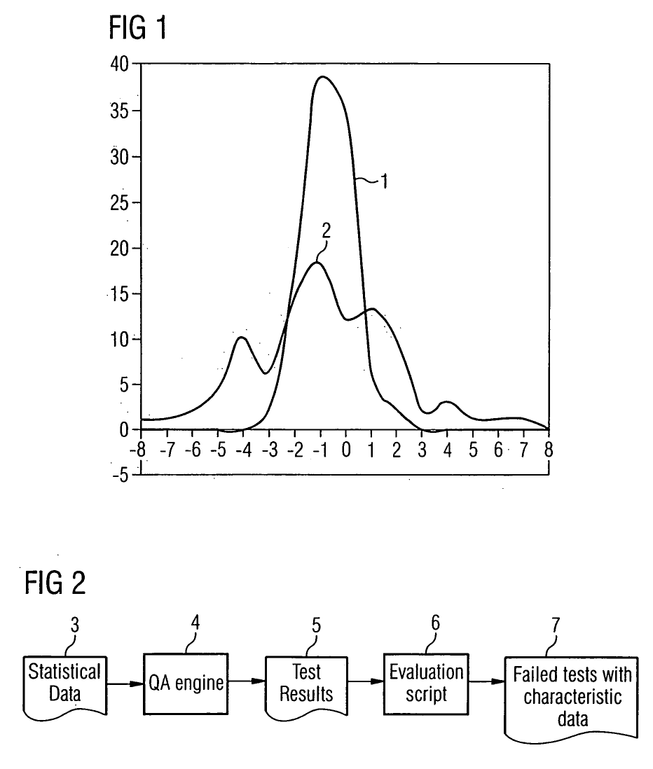

Skilled artisans appreciate that elements in the figures are illustrated for simplicity and clarity and have not necessarily been drawn to scale.

### DETAILED DESCRIPTION

Since the present invention uses some principles known in hypothesis testing in order to compare a first semiconductor-related technical system with a second semiconductor-related technical system, some technical terms used shall be explained first. More comprehensive information on the terms and tests used for realizing the present invention may be found in D.C. Montgomery, G. C. Runger, Applied Statistics and Probability for Engineers, John Wiley and Sons, N.Y., 2003, in W. A. Stahel, Statistische Datenanalyse, Vieweg und Sohn, Wiesbaden, 2002, or in B. R üger, Test- und Schatztheorie, Vol. I nad II, Oldenbourg, Munich 2002, which are basic text books illustrating general techniques of hypothesis testing and all of which are incorporated by reference in their entirety for all purposes. Further information regarding the basics of statistics may be found in the NIST- SEMATECH e-Handbook of Statistical Methods, HTTP: //www.itl.nist.gov/div898/handbook/index.htm, 2005.

Hypothesis testing is the use of statistics to determine the probability that a given hypothesis is true. In comparing a first technical system with a second technical system, this hypothesis (also called null hypothesis) may be that first statistical data characterizing the first technical system is equivalent to second statistical data characterizing the second technical system, i.e. that they correspond to the same data distribution. The alternative hypothesis would then be that the first statistical data and the second statistical data correspond to different data distributions.

A term commonly used in a hypothesis testing is the P-value, which is the probability that a statistical data distribution at least as significant as the one observed would be obtained assuming that the hypothesis were true. For the first and second statistical data above, the P-value basically represents the probability that a first statistical data at least as different from the second statistical data as the one observed will be obtained by measurement or simulation by pure chance given that the first and second technical system are equivalent. The smaller the P-value, the stronger the evidence against the hypothesis, i.e. the more probable it is that the first statistical data and the second statistical data indeed represent non-equivalent technical systems. In order to evaluate this quantitatively, the P-value is compared to an acceptable significant value α. If P≦α, the differences between the first statistical data and the second statistical data are statistically significant, i.e. not a product of pure chance which always plays a role in statistical data analysis. The value α is chosen according to the circumstances, i.e. the desired accuracy, by a use. A typical value for α would be 0.05, which would mean that if P≦α it would be 95% sure that the first statistical data and the second statistical data do not belong to equivalent technical systems.

Referring now to FIG. 2, in a block diagram the basic elements and steps of the method and apparatus of the present invention are shown. In a first block 3, first statistical data characterizing the first technical system and second statistical data characterizing the second technical system are obtained. As already explained in the background art section in detail, the first technical system and the second technical system may be simulation programs like SPICE programs simulating semiconductor devices and which programs are designed to be equivalent, for example by implementing the same transistor model in both simulation programs, and this equivalence is to be verified using the present invention. In this case, the first and second statistical data may be obtained by performing Monte-Carlo simulations, which means that random input values are fed to the simulated device and the statistical data comprises the output values from the simulated device. In the case where two semiconductor fabrication lines are to be compared, statistical data may comprise characteristic parameters of the manufactured devices, for instance threshold values of transistors.

It should be noted that the two semiconductor fabrication lines may also be the same line before and after some modification has been performed. The same holds true for the above-mentioned simulation programs.

After the first and second statistical data have been obtained, they are compared using at least one statistical test in a quality assurance engine (QA engine) 4, the results of these tests are provided as indicated by block 5. An evaluation script 6 evaluates the test results and provides information regarding the failed tests with characteristic test data as indicated by block 7. This information may be used to improve the matching between the first and second technical systems. For example, the tests performed in the QA engine 4 may indicate that the distribution of threshold values of a transistor either being a real product or simulated one are not equivalent in the first and second technical systems, thus enabling operators responsible for the implementation to specifically check this aspect of the production process and/or simulation.

Such an automatized evaluation and comparison of technical systems as indicated in FIG. 2 are helpful if a great number of parameters corresponding to a plurality of data sets from the first and second statistical data is to be evaluated. This provides an efficient tool to find those parameters which do not match, if any.

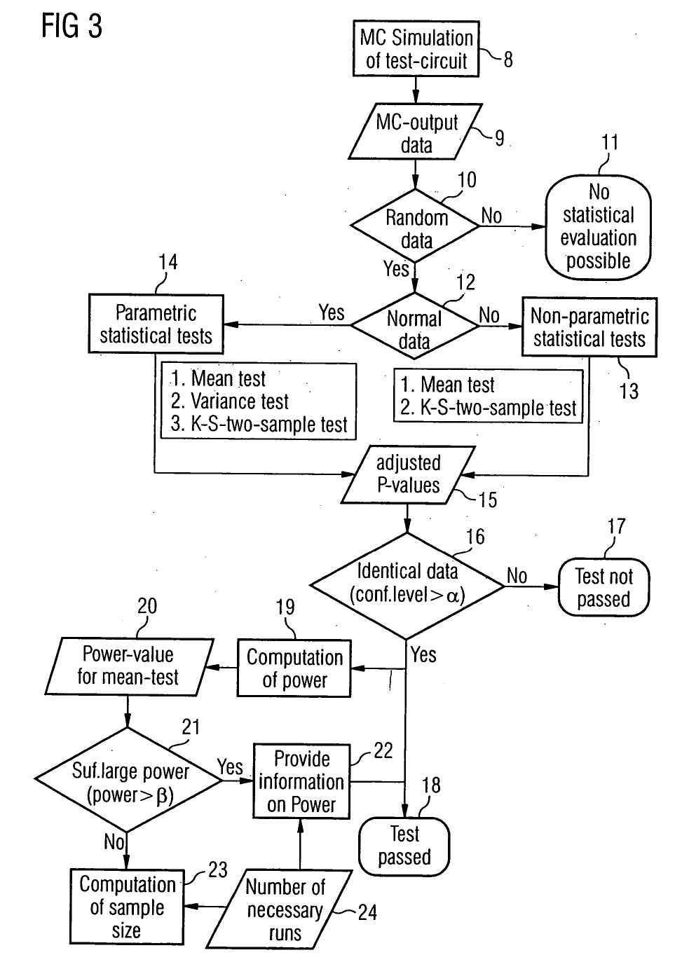

Turning now to FIG. 3, a flow diagram of an embodiment of the method of the present invention is shown in more detail. In step 8, a Monte-Carlo simulation of the technical systems to be examined is performed, for example by simulating a test circuit comprising transistors with two different simulation programs representing the first and second technical system. The output data of this Monte-Carlo simulation is provided in step 9 forming the first and second statistical data. Besides Monte-Carlo simulations, it is also possible to obtain the data by measurements as described above or by any other means.

In step 10, it is determined whether the obtained first and second statistical data is indeed random, i.e. truly statistical data. This may be done by computing the autocorrelation function of data samples of the output data provided in step 9. Through using the autocorrelation function, it may be determined whether data samples depend on other determined data samples or are truly statistical. For statistical (random) samples not dependent on each other, the autocorrelation function should be zero or close to zero.

If it turns out that the obtained data is not random data, the method is terminated in step 11 since for non-random data the statistical evaluation is generally either not possible or produces imprecise results. As an alternative, a warning may be output to a user informing him of the degree of correlation so that the user knows that the obtained results are imprecise.

If the obtained first and second statistical data is indeed random data, the method proceeds with determining whether the first and second statistical data follows a Gaussian distribution, i.e. if it is normal data. This may be done by using the so-called Shapiro-Wilk-test, which is described in S. S. Shapiro, M. B. Wilk, “An Analysis of Variance Test for Normality ”, Biometrica Vol. 52, pp. 591-611, 1965. If the first and second statistical data are normal data, in step 14 parametric statistical tests may be used to compare the first and second statistical data, whereas, if the first or second statistical data are not normal, in step 13 non-parametric statistical tests may be used.

Parametric statistical tests are those which make assumptions regarding the shape of the statistical data distribution and in particular assume that the statistical data follows a Gaussian distribution. Non-parametric statistical tests do not use such an assumption. In step 14 non-parametric statistical tests may also be performed together with the parametric statistical tests. On the other hand, some parametric statistical tests such as a mean test may also be performed in step 13 as the central limit theorem states that for large sample sizes, the distribution of the mean value becomes approximately normal, i.e. Gaussian, regardless of the distribution of the actually measured or simulated parameter.

As described above, as a null hypothesis, it is for example assumed that the first statistical data to be tested is equivalent to the second statistical data, whereas as alternative hypothesis non-equivalence is used. The tests performed in step 13 may comprise the mean test which is also known as Welch-test and a Kolmogorov-Smimov two-sample test. Additionally, a Wilcoxon-test may be performed. Information regarding these tests may be found in the references already cited, therefore, these basic statistical tests are not described here in detail. In step 14, the mean test, a variance test (or F-test) and the Kolmogorov-Smimov two-sample test may be performed. Other statistical tests may also be used.

In each case, in step 15 the above-mentioned P-values are calculated for each test and compared with respective α values, i.e. confidence levels, as described above. However, when a plurality of tests is performed, the α value generally is modified since with a greater number of tests, the chance that at least one of the tests rejects the null hypothesis inappropriately, i.e. falsely states that the first and second statistical data are not equivalent, increases with the number of tests. One example of an easy correction is to divide the total confidence level desired by the number of tests performed. The total confidence level is also known as significance. In the example provided above, α=0.05 corresponding to a probability of 95% that the null hypothesis is not rejected inappropriately. The number of tests performed in FIG. 3 is: 3 if the three tests of step 14 have been performed and 2 if the two tests of step 13 have been performed. This correction is known as the Bonferroni correction. Alternative methods for adjusting the results if a plurality of tests performed are known from Y. Hochberg, “A sharper Bonferroni Procedure for Multiple Tests of Significance ”, Biometrika 75, 1988, pp. 800-803, S. Holm, “A Simple Sequentially Rejective Multiple Test Procedure ”, Scandinavian Journal of Statistics, 6, 1979, pp. 65-70, G. Hommel, “A Stagewise Rejective Multiple Test Procedure Based on a Modified Bonferroni Test ”, Biometrica 75, 1988, pp. 383-386, which may be used instead of the explained Bonferroni correction.

If all the tests are passed with the adjusted α values, which is checked in step 16, the first and second statistical data are equivalent or identical with a confidence level of a. If this is not the case, in step 17 it is output that the test is not passed, possibly together with information regarding the deviations detected and/or information which tests have not been passed. Otherwise, the test has been passed, which is output in step 18.

As an option, in steps 19-24 additional information regarding the power may be obtained. The power gives the probability of not committing a type II error. In the present case, a type II error is accepting the first and second statistical data as equivalent when in fact they are not equivalent. This ability is not to be confused with the α-value explained above, which is related to a type I error, i.e. finding that the first and second statistical data are not equivalent (rejecting the null hypothesis) when in truth they are equivalent.

In step 19, the power is computed and in step 20, the power is output. In step 21, the power is compared with a predetermined value β, which corresponds to a desired power. If the power is greater than this desired power, in step 22 the power is output as information to the user. If the power is below β, in step 23 a sample size is calculated to obtain the desired power corresponding to a number of runs of the Monte-Carlo simulation provided in step 24. This may be done since, in general, statistical information increases in accuracy with increasing sample size, i.e. the more individual samples the obtained statistical data contains. Also in this case, in step 22 information on the power and the number of runs is provided.

As shown, this calculation in step 19-24 is optional and done for information purposes only without influencing whether the test is passed or not. However, it would also be possible to require both the desired confidence level and the desired power of the result to be achieved.

To implement the method, an apparatus which usually will have the form of a computer system is used. The method may be implemented using available tools for statistical analysis like R, which is a language and an environment for statistical computing and graphics developed at Bell Laboratories (formerly AT&T, now Lucent Technologies) and is available as free software under the terms of the free software foundation's GNU General Public License. However, other tools may also be used.

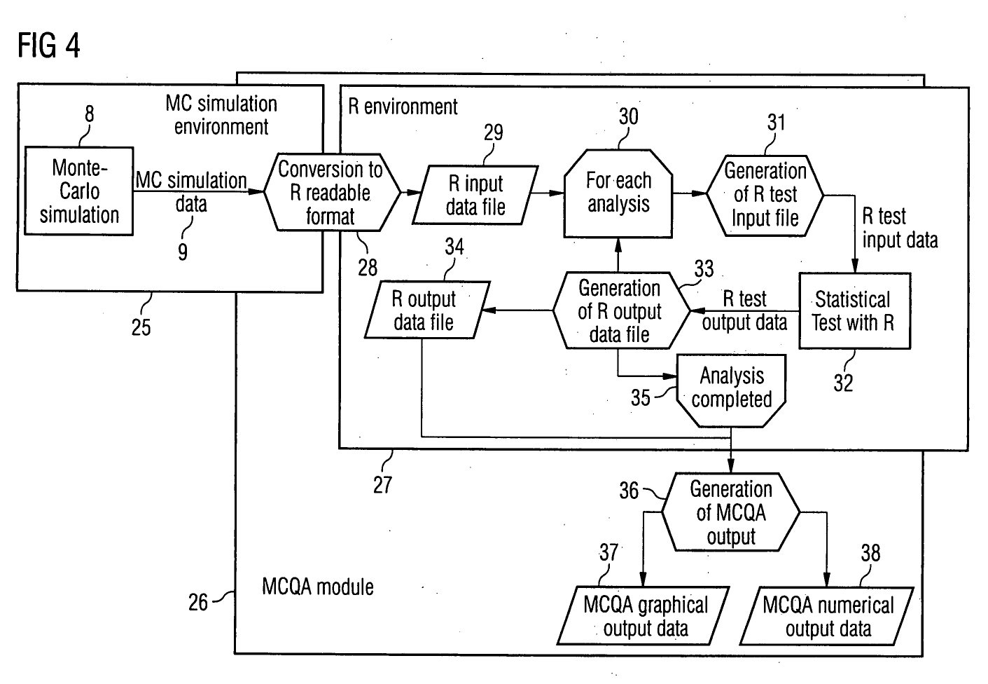

In FIG. 4, a possible implementation of the method in a computer system is shown. Similar to FIG. 3, the implementation is adapted to the case of Monte-Carlo simulations, whereas for the cases where the first and second statistical data are obtained by measurements (e.g. when comparing semiconductor fabrication lines) a Monte-Carlo simulation environment 25 of FIG. 4 would be replaced by the appropriate measurement devices. In block 8 corresponding to step 8 of FIG. 3, the Monte-Carlo simulations are performed yielding Monte-Carlo simulation data 9. In a block 28, this data is converted to an R readable format, i.e. a format readable by the R software environment, which has already been mentioned and which is used to implement the embodiment shown in FIG. 4. This conversion yields R input data file 29. The conversion may occur in a MCQA (Monte-Carlo quality assurance) module 26.

The MCQA also contains elements 30 to 33, which form a loop. In element 30, a command is generated for each analysis to be performed and supplied to block 31 to generate an R test input file for the respective analysis to be performed. Analysis here relates to the steps 10, 12, 13 and 14 in FIG. 3. Also, if the Monte-Carlo simulation simulates a plurality of parameters leading to the first and second statistical data, each comprising a plurality of subsets that each relate to a different parameter, the analysis is performed for each subset. In block 32, the respective statistical tests are performed, which may be easily done in the R environments since procedures are provided for the various tests. The test output data generated by the statistical tests in block 33 is added to an R output data file 34.

This cycle is repeated for each analysis until in block 35 it is determined that the analysis is completed. After this, the output is generated based on the output data file 34 in step 36. The output may comprise both graphical output data 37 and numerical output data 38. Each of these may show deviations between the first and second statistical data. This generation of MCQA output 36 may be programmed in R or implemented in any programming language.

As a matter of course, the embodiments shown are only intended to serve as examples for implementing the invention, and other programming environments and other statistical tests may be used for implementing the invention. Moreover, the invention may be applied to other semiconductor-related technical systems than the one described above, as long as they may be characterized by statistical data. Furthermore, a third or more technical systems may be compared with the first and second technical systems.

Thus, a method and an apparatus for comparing first and second systems (e.g. semiconductor-related technical systems such as simulation programs for semiconductor devices or semiconductor fabrication lines) are provided. The first and second technical systems are characterizable by statistical data, such that an automated evaluation of the correspondence between the technical systems may be performed. The first and second technical systems are equivalent if the first statistical data corresponds to the same distribution as the second statistical data with a probability greater than a given limit. Information regarding differences between the first and second technical systems may be provided. This information may be helpful in improving the technical systems or modifying the technical systems such that they become equivalent. In many cases, the first and second technical systems are designed to be equivalent, and the method may be used to verify this equivalence.

The first and second statistical data may be determined by Monte-Carlo simulations or by measurements. Various statistical tests can be used, including a test comparing the distribution shapes of the first and second statistical data (e.g. Kolmogorov-Smimov-two-sample test) and a mean test comparing the mean values of the first and second statistical data, a variance test comparing the variances of the first and second statistical data. If more than one test is used, confidence levels of the tests are adjusted accordingly, for example using the Bonferroni principle. The tests chosen to compare the first and second statistical data may be determined depending on whether the first and second statistical data follow a normal, i.e. Gaussian distribution, which may be determined using a Shapiro-Wilk-test. The power of the tests may additionally be provided. In addition, a check may be performed whether the first and second statistical data truly represent random data by computing the autocorrelation function. If the first and second statistical data are not random data, the method may be stopped or a warning to the user may be output. This is advantageous since statistical tests are only applicable to random data and produce false or inaccurate results for correlated data.

It is therefore intended that the foregoing detailed description be regarded as illustrative rather than limiting, and that it be understood that it is the following claims, including all equivalents, that are intended to define the spirit and scope of this invention. Nor is anything in the foregoing description intended to disavow scope of the invention as claimed or any equivalents thereof.

We claim:

1. A method for comparing a first semiconductor-related technical system with a second semiconductor-related technical system, the method comprising:
providing first statistical data characterizing the first technical system,
providing second statistical data characterizing the second technical system,
performing a statistical test comparing the first statistical data with the second statistical data, and
determining whether the first and second technical system are equivalent depending on the result of the statistical test.

2. The method according to claim 1, wherein the statistical test comprises a test taking shapes of distributions of the first and second statistical data into account.

3. The method according to claim 1, wherein providing the first and second statistical data comprises at least one of:
performing a simulation for obtaining at least one of the first or second statistical data, or
measuring at least one of the first or second statistical data.

4. The method according to claim 1, further comprising evaluating whether the first and second statistical data have a normal distribution.

5. The method according to claim 4, further comprising selecting the statistical test depending on the result of the evaluation.

6. The method according to claim 5, wherein the checking comprises computing an autocorrelation function of the first and second statistical data .

7. The method according to claim 5, further comprising terminating the method if at least one of the first or second statistical data are not random data.

8. The method according to claim 5, wherein the first and second statistical data each comprise a plurality of data subsets related to different parameters of the first and second technical systems, respectively.

9. The method according to claim 5, wherein the first and second technical system are chosen from the group consisting of a semiconductor fabrication line and a semiconductor device simulating program and, if the first and second technical systems each comprise semiconductor device simulation programs, the first technical system includes a first statistical model of a semiconductor component and the second technical system comprises a second statistical model of a semiconductor component, and the first and second statistical models are designed to be equivalent.

10. An apparatus for comparing a first semiconductor-related technical system with a second semiconductor-related technical system, the apparatus comprising:
a data provider to provide first statistical data characterizing the first technical system and second statistical data characterizing the second technical system,
a calculator to perform a statistical test to compare the first statistical data with the second statistical data, and
a determiner to determine whether the first and second technical systems are equivalent depending on an output of the calculator.

11. The apparatus according to claim 10, wherein the data provider comprises at least one of:
a measurer to measure at least one of the first or second statistical data, or
a simulation engine to perform a simulation to obtain at least one of the first or second statistical data.

12. The apparatus according to claim 10, wherein the statistical test comprises a test that takes shapes of distributions of the first and second statistical data into account.

13. The apparatus according to claim 10, further comprising an evaluator to evaluate whether the first and second statistical data have a normal distribution

14. The apparatus according to claim 13, further comprising a selector to select the statistical test depending on an output of the evaluator.

15. An apparatus for comparing a first semiconductor-related technical system with a second semiconductor-related technical system, the apparatus comprising:
a data provider to provide first statistical data characterizing the first technical system and second statistical data characterizing the second technical system,
a calculator to perform a statistical test to compare the first statistical data with the second statistical data,
a determiner to determine whether the first and second technical systems are equivalent depending on an output of the calculator, and
a checker to check whether the first and second statistical data are random data.

16. The apparatus according to claim 15, wherein the checker comprises an autocorrelator to compute an autocorrelation function of the first and second statistical data.

17. The apparatus according to claim 15, further comprising a termination device to terminate processing of the first and second statistical data if at least one of the first or second statistical data are not random data.

18. The apparatus according to claim 15, wherein the first and second statistical data each comprise a plurality of data subsets related to different parameters of the first and second technical system, respectively.

19. The apparatus according to claim 15, wherein the first and second technical system are chosen from the group consisting of a semiconductor fabrication line and a semiconductor device simulating program and, if the first and second technical systems each comprise semiconductor device simulation programs, the first technical system includes a first statistical model of a semiconductor component and the second technical system comprises a second statistical model of a semiconductor component, and the first and second statistical models are designed to be equivalent.

20. An apparatus for comparing a first semiconductor-related technical system with a second semiconductor-related technical system, the apparatus comprising:
a data providing means for providing first statistical data characterizing the first technical system and second statistical data characterizing the second technical system,
calculation means for performing at least one statistical test for comparing the first statistical data with the second statistical data,
determination means for determining whether the first technical system and the second technical system are equivalent depending on the output of the calculation means.

21. The apparatus according to claim 20, wherein the data providing means comprise at least one of:
measuring means for measuring at least one of the first or second statistical data, or
simulation means for performing a simulation for obtaining at least one of the first or second statistical data.

22. The apparatus according to claim 20, further comprising checking means for checking whether the first and second statistical data are random data.

23. The apparatus according to claim 22, wherein the checking means comprise calculation means designed for computing the autocorrelation function of the first statistical data and the second statistical data.

24. The apparatus according to claim 20, further comprising evaluation means for evaluating whether the first and second statistical data have a normal distribution.
